(19) United States
(12) Patent Application Publication
(10) Pub. No.: US 2019/0341160 A1
(43) Pub. Date: Nov. 7, 2019

(54) DEVICE FOR STORING DANGEROUS MINERALS

(71) Applicant: Cockerill Maintenance & Ingenierie S.A., Seraing (BE)

(72) Inventors: Philippe Fontaine, Plaineveaux (BE); Aldo Gressani, Grace-hollogne (BE)

(21) Appl. No.: 15/769,763

(22) PCT Filed: Oct. 21, 2016
(86) PCT No.: PCT/EP2016/075467

§ 371 Date: Apr. 20, 2018

(30) Foreign Application Priority Data
Oct. 22, 2015 (FR) 1560100

(51) Int. Cl. G21C 19/40; G21F 5/08; B65D 81/107; G21F 9/22

(52) U.S. Cl. CPC G21C 19/40; G21F 9/22; B65D 81/107; G21F 5/08

(57) ABSTRACT

A device for storing dangerous materials includes a mount supporting a containment enclosure for containing dangerous materials. The mount includes a frame surmounted by support members that support the enclosure, each support member including a first element secured to the mount and a second element for supporting the enclosure and that is mounted so as to be movable relative to the first element in a substantially vertical sliding direction. The mount includes at least one impact absorber interposed between the two elements, the at least one impact absorber preventing relative movement between the two elements so long as a force applied to the at least one impact absorber by the two elements is no greater than a predetermined threshold. The at least one impact absorber deforms plastically so as to allow the two elements to move relative to each other.

### CROSS-REFERENCE TO PRIOR APPLICATIONS

This application is a U.S. National Phase application under 35 U.S.C. § 371 of International Application No. PCT/EP2016/075467, filed on Oct. 21, 2016, and claims benefit to French Patent Application No. FR 1560100, filed on Oct. 22, 2015. The International Application was published in French on Apr. 27, 2017 as WO 2017/068165 under PCT Article 21(2).

### FIELD

The present invention relates to storing dangerous materials. By way of example, such dangerous materials may be radioactive waste.

### BACKGROUND

In nuclear-fuel electricity power stations, a portion of the used working equipment is conventionally stored in dedicated packaging, which is itself finally stored in bunkers when the used working equipment is radioactive. Such storage bunkers are located on the site of the nuclear power station, outside the building housing the nuclear reactor proper. The used working equipment includes in particular tubes for guiding control clusters of the nuclear reactor.

It is therefore necessary to extract the used working equipment from the building housing the nuclear reactor in order to take it to the storage bunkers. To do this, it is known to use storage devices comprising a mount supporting the containment enclosure for containing the dangerous materials. The containment enclosure comprises a shielded tubular barrel having a first end portion surrounded by additional shielding, and at its opposite end, a second end that is closed by a removable cover for enabling guide tubes to be inserted into the enclosure in such a manner that the most radioactive portion of the guide tubes lies in the first end portion of the shielded barrel. The mount comprises a frame surmounted by three support members: two rear support members extend facing each other to support the first end portion of the shielded barrel via pivots secured to the shielding, and a front support member on which the second end portion of the shielded barrel rests so that the enclosure extends horizontally. The mount also has attachment means enabling hoist means to be hitched thereto in order to lift the device as a whole and load it onto a vehicle for moving the device from the reactor building to the storage bunker, and vice versa, or to any other location on site.

The device is thus subjected to handling, in particular to being hoisted, thus running the risk of being dropped. Although such a drop would not make a hole in the shielded barrel, given the maximum height at which the device might be found while in use, a drop could lead to deformation of the cover or of the shielded barrel in the vicinity of the cover, and thus to a break in the sealing of the containment.

It might be envisaged that the strength of the packaging could be increased, e.g. by increasing the thickness of the steel constituting the shielded barrel. Nevertheless, that would lead to a significant increase in the weight of the device, possibly to such an extent that it would be necessary to redimension the hoist means, or indeed to exceed the maximum acceptable weight that can be handled in the power station.

In addition, the size of the device depends on the dimensions of passages in the reactor building and also on the inside dimensions of the storage bunkers, and in indeed on conventional transport loading gauges, which is also constraining on the general deign of the device.

### SUMMARY

In an embodiment, the present invention provides a device for storing dangerous materials, the device comprising: a mount supporting a containment enclosure configured to contain dangerous materials, the mount comprising: a frame surmounted by support members configured to support the enclosure, each support member comprising a first element secured to the mount and a second element configured to support the enclosure and that is mounted so as to be movable relative to the first element in a substantially vertical sliding direction; and at least one impact absorber interposed between the two elements, the at least one impact absorber being configured to prevent relative movement between the two elements so long as a force applied to the at least one impact absorber by the two elements is no greater than a predetermined threshold, and configured to deform plastically so as to allow the two elements to move relative to each other when the force applied to the at least one impact absorber by the two elements is greater than the predetermined threshold, the at least one impact absorber having a partitioned volume defined by substantially vertically walls in order to form a cellular structure.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is an elevation view of a device in accordance with the invention;

FIG. 2 is an end view of the device;

FIG. 3 is an enlarged view in perspective of a zone III in FIG. 1; and

FIG. 4 is an enlarged view in perspective of a zone IV of FIG. 1.

### DETAILED DESCRIPTION

To this end, the invention provides a device for storing dangerous materials, the device comprising a mount supporting a containment enclosure for containing dangerous materials, the mount comprising a frame surmounted by support members for supporting the enclosure. Each support member comprises a first element secured to the mount and a second element that supports the enclosure and that is mounted to be movable relative to the first element in a substantially vertical sliding direction. At least one impact absorber is interposed between the two elements to prevent relative movement between them so long as a force applied to the impact absorber by the element is no greater than a predetermined threshold, and to deform plastically so as to allow the elements to move relative to each other when the force applied to the impact absorber by the elements is greater than the predetermined threshold. The impact absorber has a partitioned volume defined by substantially vertical walls in order to form a cellular structure.

The predetermined threshold corresponds to a force that the device can withstand while guaranteeing the integrity of the containment. The invention is based on the assumption that, in the event of a fall, the device would strike the ground via the mount: the two elements of each impact absorber would then tend to move towards each other, and if the applied force is greater than the threshold, the two elements would be compressed together, thereby absorbing the impact. The plastic deformation of the impact absorber enables a fraction of the energy of the impact to be absorbed, thereby limiting the risk of the residual energy being sufficient to deform the barrel. Impact absorbers of cellular structure present good capacity for absorbing energy relative to their weight and their size.

Other characteristics and advantages of the invention appear on reading the following description of particular, non-limiting embodiments of the invention.

The invention is described herein in application to storing radioactive waste constituted by control bar guide tubes of a nuclear reactor. Nevertheless, other applications are naturally possible, such as for example storing toxic chemicals.

With reference to the figures, the storage device of the invention comprises a mount 1 supporting a containment enclosure 2 for containing radioactive waste.

The enclosure 2 may comprise a shielded barrel 20 of tubular shape, having a first end portion 21 surrounded by additional shielding 23, and at its opposite end, a second end portion 22 closed by a removable cover 24 that is held in place by bolts 25. Two diametrically opposite pivots 26 project from the additional shielding 23, and two diametrically opposite hoist trunions 27 project from the second end portion 22 of the shielded barrel 20. The pivots 26 and the hoist trunions 27 are arranged in a common longitudinal midplane of the shielded barrel 20. The inside structure of the shielded barrel 20, which includes means for stowing guide tubes, is of no relevance to the invention and is therefore not described in greater detail herein.

The mount 1 comprises a frame 3 made up of an assembly of girders and surmounted by three support members for the enclosure 2 that are arranged at the vertices of an isosceles triangle of height extending parallel to the central axis of the shielded barrel 20, namely two rear support members 4, each for supporting one of the pivots 26, and a front support member 5 for supporting the second end portion 22 of the shielded enclosure 20 in a zone in the neighborhood of a bottom generator line of the second end portion 22. The shielded enclosure 20 has an axis that is substantially horizontal when it is resting on the support members 4 and 5.

Each rear support member 4 comprises a first element 4.1 secured to the mount 1 and a second element 4.2 that supports the enclosure 2 and that is mounted to be movable relative to the first element 4.1 in a substantially vertical sliding direction. More precisely in this example, the second element 4.2 has a bottom portion mounted to slide in a top portion of the first element 4.1, and a top portion supporting an open bearing 4.21 that pivotally receives the pivot 26 of the enclosure 2 and that is closed by a removable latch 4.22. The bottom portion of the first element 4.1 defines a housing 4.11 of vertical size that depends on the relative position of the elements 4.1 and 4.2.

The housing 4.11 contains a first impact absorber 6.1 and a second impact absorber 6.2 resting on a plate 6.3, itself resting on the first impact absorber 6.1. The bottom portion of the second element 4.2 rests on the second impact absorber 6.2. The impact absorbers 6.1 and 6.2 are thus interposed between the two elements 4.1 and 4.2 so as to prevent them moving relative to each other so long as the force applied to each of the impact absorbers by the elements 4.1 and 4.2 is not greater than a predetermined threshold, and to deform plastically so as to allow the elements 4.1 and 4.2 to move relative to each other when the force applied to the impact absorbers by the elements 4.1 and 4.2 is greater than the predetermined threshold. The first impact absorber 6.1 is plastically deformable above a first force threshold, and the second impact absorber is plastically deformable above a second force threshold that is less than the first force threshold. For example, the second impact absorber 6.2 may be arranged to absorb an impact that results from dropping 13 centimeters (cm) and the first impact absorber 6.1 may be arranged to absorb an impact resulting from dropping 150 cm.

The housing 4.11 is defined by an outside wall 4.12 of the first element 4.1 of the support member 4. Said outside wall 4.12 includes an opening 4.13 of position and dimensions that are suitable for enabling the second impact absorber 6.2 to be inserted into the housing 4.11 and for enabling the second impact absorber 6.2 to be extracted from the housing 4.11 (under which circumstances, the second element 4.2 needs to be relieved of the weight of the enclosure 2 by using hoist means). The opening 4.13 is advantageous, since it can happen that the device is subjected to an impact leading to the second impact absorber 6.2 being flattened but not the first impact absorber 6.1: under such circumstances, the second impact absorber 6.2 can be replaced without needing to disassemble the outer wall 4.12. Introducing the first impact absorber 6.1 and the plate 6.3 into the housing 4.11, and extracting them from the housing 4.11 requires the outer wall 4.12 to be disassembled (under such circumstances, likewise, the second element 4.2 needs to be relieved of the weight of the enclosure 2 by using hoist means). Naturally, it is also possible to insert the second impact absorber 6.2 into the housing 4.11 and to extract it therefrom by disassembling the outer wall 4.12.

Vertical threaded rods 8 that are screwed into the mount 1 pass through each of the rear support elements 4 and are provided with nuts and Belleville type washers opposing upward movement of the second element 4.2 beyond the position defined by the nuts. Such movement might occur during normal travel of a vehicle including the device (acceleration, braking, . . . ).

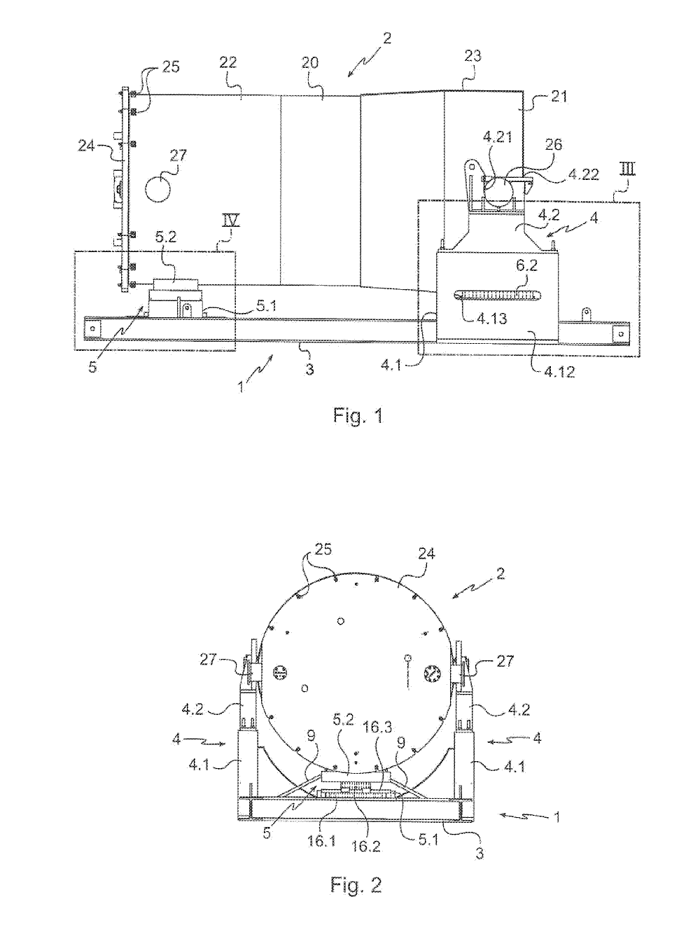

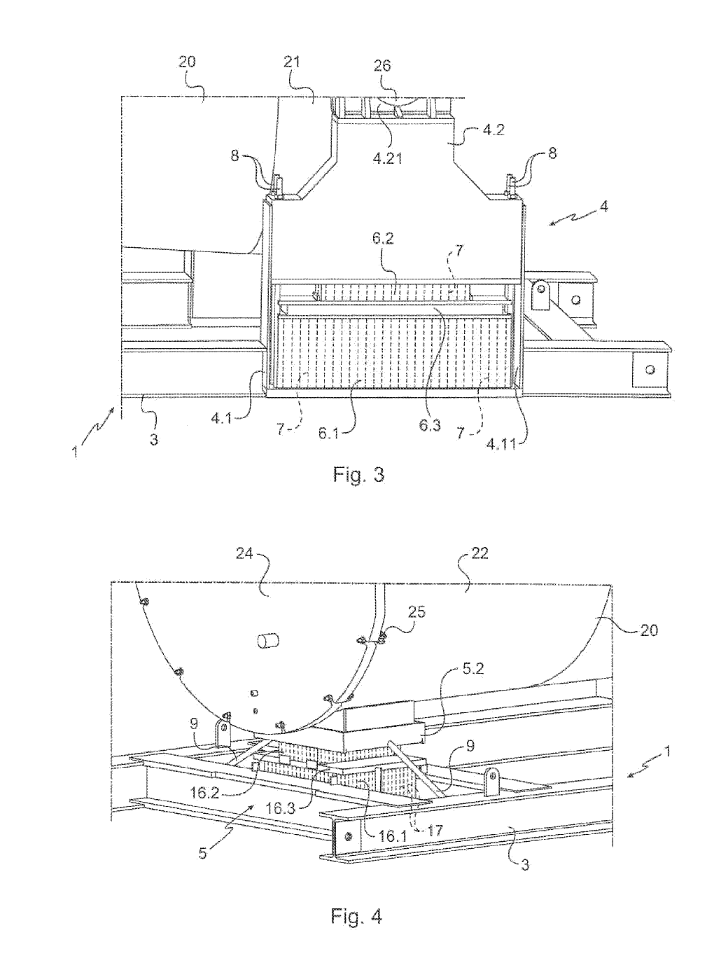

Each front support member 5 (shown without its outside walls in FIGS. 2 and 4) comprises a first element 5.1 secured to the mount 1 and a second element 5.2 that supports the enclosure 2 and that is mounted to be movable relative to the first element 5.1 in a substantially vertical sliding direction. More precisely in this example, the second element 5.2 has a bottom portion mounted to slide in a top portion of the first element 5.1 and a top portion on which the second end portion 22 of the shielded enclosure 20 rests directly. The bottom portion of the first element 5.1 defines a housing of vertical size that depends on the relative position of the elements 5.1 and 5.2.

This housing contains a first impact absorber 16.1 and a second impact absorber 16.2 resting on a plate 16.3, itself resting on the first impact absorber 16.1. The bottom portion of the second element 5.2 rests on the second impact absorber 16.2. The impact absorbers 16.1 and 16.2 are thus interposed between the two elements 5.1 and 5.2 to prevent relative movement between them so long as the force applied to each of the impact absorbers by the elements 5.1 and 5.2 is no greater than a predetermined threshold, and to deform plastically so as to allow the elements 5.1 and 5.2 to move relative to each other when the force applied on the impact absorbers by the elements 5.1 and 5.2 is greater than the predetermined thresholds. The first impact absorber 16.1 is plastically deformable beyond a first force threshold and the second impact absorber is plastically deformable beyond a second force threshold that is less than the first force threshold. By way of example, the second impact absorber 16.2 may be arranged to absorb an impact resulting from a drop of 13 cm, and the first impact absorber 16.1 may be arranged to absorb an impact resulting from a drop of 150 cm.

Each impact absorber 6.1, 6.2, 16.1, and 16.2 has a partitioned volume defined by substantially vertical walls 7 and 17 in order to constitute a cellular structure of honeycomb form in this example. The cells are open at their top and bottom ends. In this example, the impact absorbers 6.1, 6.2, 16.1, and 16.2 are made of metal. In this example, the metal is an aluminum alloy. The walls 7, 17 have a thickness of less than 100 micrometers (μm). Naturally, the material that is chosen and the wall thickness that is chosen depend on dimensioning constraints (force to be supported, space available for the impact absorber, . . . ).

It should be observed that in the embodiment shown, the second impact absorber 6.2, 16.2 has dimensions extending transversely to the sliding direction that are smaller than the transverse dimensions of the first impact absorber 6.1, 16.1, such that the load-bearing surface areas are different. The function of the plate 6.3, 16.3 is to transfer the forces exerted by the second impact absorber 6.2, 16.2 over the entire top surface area of the first impact absorber 6.1, 16.1.

It should be observed that the presently-described concept also makes it possible, when designing the device, to adapt to the constraints that are to be complied with (height of drop, mass to be supported, . . . ) merely by appropriately dimensioning the impact absorbers and/or increasing their numbers.

The front support member 5 is not arranged to support lateral forces: the second element 5.2 is thus connected to the mount 1 by ties 9 (cables) that extend in a diametral plane of the enclosure 2 so as to take up any lateral forces that might be exerted on the mount 1. The ties 9 must not oppose downward vertical movement of the second element 5.2. In this example, the ties 9 are formed by cables that are tensioned by means that are not shown.

Naturally, the invention is not limited to the embodiments described, but covers any variant coming within the ambit of the invention as defined by the claims.

In particular, the number of support members may be other than three.

Only some of the support members need be fitted with an impact absorber (e.g. in the vicinity of the location where the enclosure is the weakest).

The support members may be fitted with some other number of impact absorbers.

The impact absorber may be made of materials other than an aluminum alloy, and for example it may be made out of steel or out of a composite material. The cellular structure may be of some other form, for example its cells could be of quadrilateral shape.

The first impact absorber and the second impact absorber may be of structures that are different or identical.

Each tie 9 may be replaced by a telescopic rod comprising two portions that are connected together by a breakable pin.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A device for storing dangerous materials, the device comprising:
a mount supporting a containment enclosure configured to contain dangerous materials, the mount comprising:
a frame surmounted by support members configured to support the enclosure, each support member comprising a first element secured to the mount and a second element configured to support the enclosure and that is mounted so as to be movable relative to the first element in a substantially vertical sliding direction; and
at least one impact absorber interposed between the two elements, the at least one impact absorber being-configured to prevent relative movement between the two elements so long as a force applied to the at least one impact absorber by the two elements is no greater than a predetermined threshold, and configured to deform plastically so as to allow the two elements to move relative to each other when the force applied to the at least one impact absorber by the two elements is greater than the predetermined threshold, the at least one impact absorber having a partitioned volume defined by substantially vertically walls in order to form a cellular structure.

2: The device according to claim 1, wherein the cellular structure of the at least one impact absorber comprises a honeycomb.

3: The device according to claim 1, wherein the at least one impact absorber comprises a composite material.

4: The device according to claim 1, wherein the at least one impact absorber is comprised of metal.

5: The device according to claim 4, wherein the metal includes aluminum, and
wherein the walls of the at least one impact absorber are of a thickness that is less than 100 μm.

6: The device according to claim 1, wherein the at least one impact absorber comprises two impact absorbers,
wherein the two impact absorbers are interposed between the two elements, and
wherein the two impact absorbers comprise a first impact absorber that is plastically deformable above a first force threshold, and a second impact absorber that is plastically deformable above a second force threshold that is less than the first force threshold.

7: The device according to claim 6, further comprising a force distribution plate is interposed between the two impact absorbers.

8: The device according claim 1, wherein the at least one impact absorber is contained in a housing defined by an outer wall of the support member, the outer wall including an opening of position and dimensions that enable the at least one impact absorber to be inserted into the housing and the at least one impact absorber to be extracted from the housing.

9: The device according to claim 1, wherein the support members comprise two rear support members and one front support member.

10: The device according to claim 9, wherein the second element of the front support member is connected to the mount by ties extending in a diametral plane of the containment enclosure so as to take up any lateral forces exerted on the mount, the ties being arranged so as to not oppose downward vertical movement of the second element.

11: The device according to claim 10, wherein the ties comprise tensioned cables.

12: The device according to claim 1, wherein the containment enclosure is tubular in shape and has a central axis that is substantially horizontal when the containment enclosure is resting on the support members.
